(19) United States
(12) Patent Application Publication
(10) Pub. No.: US 2026/0352916 A1
(43) Pub. Date: Nov. 5, 2026

(54) MEDIA CONTENT DISPLAY METHOD AND APPARATUS, DEVICE, AND STORAGE MEDIUM

(71) Applicant: Beijing Zitiao Network Technology Co., Ltd., Beijing (CN)

(72) Inventors: Siqi HE, Beijing (CN); Mengying FANG, Beijing (CN)

(21) Appl. No.: 19/120,744

(22) PCT Filed: Oct. 11, 2023
(86) PCT No.: PCT/CN2023/123890

§ 371 Date: Apr. 11, 2025

(30) Foreign Application Priority Data
Oct. 13, 2022 (CN) 202211254768.2

(51) Int. Cl. H04N 21/431; H04N 21/81

(52) U.S. Cl. CPC H04N 21/4318; H04N 21/8113

(57) ABSTRACT

Disclosed are a media content display method and apparatus, a device, and a storage medium. The media content display method includes: displaying a first media stream on a presenting page, where the media stream includes a media stream corresponding to a shared interaction between a first user and at least one second user, and the first media stream includes a shared media content in a first type of preset media form; and switching, in response to a preset type switching operation, from displaying the first media stream to displaying a second media stream on the presenting page, where the second media stream includes a shared media content in a second type of preset media form, and the second type of preset media form is different from the first type of preset media form.

### CROSS-REFERENCE TO RELATED APPLICATION(S)

This application claims priority to Chinese Patent Application No. 202211254768.2, filed with the China National Intellectual Property Administration on Oct. 13, 2022, which is incorporated herein by reference in its entirety.

### FIELD

The present disclosure relates to the technical field of Internet, and for example, relates to a media content display method and apparatus, a device, and a storage medium.

### BACKGROUND

With the rapid development of Internet technology and terminal technology, interactions between users are becoming more and more convenient, and the multiple users can share the same media stream content, thereby achieving a shared interaction based on the shared media content.

### SUMMARY

The present disclosure provides a media content display method and apparatus, a storage medium, and a device.

In a first aspect, the present disclosure provides a media content display method, including:
displaying a first shared media stream on a target page, where the shared media stream includes a media stream corresponding to a shared interaction between a first user and at least one second user, and the first shared media stream includes a shared media content in a first type of preset media form; and
switching, in response to a preset type switching operation, from displaying the first shared media stream to displaying a second shared media stream on the target page, where the second shared media stream includes a shared media content in a second type of preset media form, and the second type of preset media form is different from the first type of preset media form.

In a second aspect, the present disclosure further provides a media content display apparatus, including:
a shared media stream display module, configured to display a first shared media stream on a target page, where the shared media stream includes a media stream corresponding to a shared interaction between a first user and at least one second user, and the first shared media stream includes a shared media content in a first type of preset media form; and
a shared media stream switching module, configured to switch, in response to a preset type switching operation, from displaying the first shared media stream to displaying a second shared media stream on the target page, where the second shared media stream includes a shared media content in a second type of preset media form, and the second type of preset media form is different from the first type of preset media form.

In a third aspect, the present disclosure further provides an electronic device. The electronic device includes:
one or more processors; and
a storage apparatus, configured to store one or more programs.

The one or more programs, when executed by the one or more processors, cause the one or more processors to implement the above media content display method.

In a fourth aspect, the present disclosure further provides a storage medium including computer-executable instructions, where the computer-executable instructions, when executed by a computer processor, are used to perform the above media content display method.

In a fifth aspect, the present disclosure further provides a computer program product, including a computer program carried on a non-transitory computer-readable medium. The computer program includes program code used to perform the above media content display method.

### BRIEF DESCRIPTION OF THE DRAWINGS

FIG. 1 is a scenario architecture diagram of an applicable application scenario for a media content display method according to an embodiment of the present disclosure;

FIG. 2 is a schematic flowchart of a media content display method according to an embodiment of the present disclosure;

FIG. 3 is a schematic diagram of an interface interaction according to an embodiment of the present disclosure;

FIG. 4 is a schematic diagram of another interface interaction according to an embodiment of the present disclosure;

FIG. 5 is a schematic diagram of another interface interaction according to an embodiment of the present disclosure;

FIG. 6 is a schematic flowchart of another media content display method according to an embodiment of the present disclosure;

FIG. 7 is a schematic diagram of another interface interaction according to an embodiment of the present disclosure;

FIG. 8 is a schematic diagram of a structure of a media content display apparatus according to an embodiment of the present disclosure; and

FIG. 9 is a schematic diagram of a structure of an electronic device according to an embodiment of the present disclosure.

### DETAILED DESCRIPTION OF EMBODIMENTS

Embodiments of the present disclosure will be described with reference to the accompanying drawings below. Although the accompanying drawings show some embodiments of the present disclosure, the present disclosure may be implemented in various forms, and these embodiments are provided for understanding the present disclosure. The accompanying drawings and the embodiments of the present disclosure are for exemplary purposes only.

A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

Concepts such as “first” and “second” mentioned in the present disclosure are only for distinguishing different apparatuses, modules, or units, and are not intended to limit the order or relation of interdependence of functions performed by these apparatuses, modules, or units.

Modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are provided for illustrative purposes only, and are not used to limit the scope of these messages or information.

Before the use of the technical solutions disclosed in the embodiments of the present disclosure, a user shall be informed of the type, range of use, application scenarios, etc., of personal information involved in the present disclosure in an appropriate manner in accordance with the relevant laws and regulations, and the authorization of the user shall be obtained.

For example, in response to reception of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an implementation, in response to the reception of the active request from the user, the method for sending the prompt message to the user may be, for example, a pop-up window, in which the prompt message may be presented in text. Further, the pop-up window may also carry a selection control for the user to choose whether to “agree” or “disagree” to provide the personal information to the electronic device.

The above notification and user authorization obtaining process is only illustrative, which does not limit the implementations of the present disclosure, and other methods that comply with relevant laws and regulations may also be applied to the implementations of the present disclosure.

Data (including the data itself, and data acquisition, or usage) involved in the technical solutions should comply with the requirements of corresponding laws and regulations, and relevant stipulations.

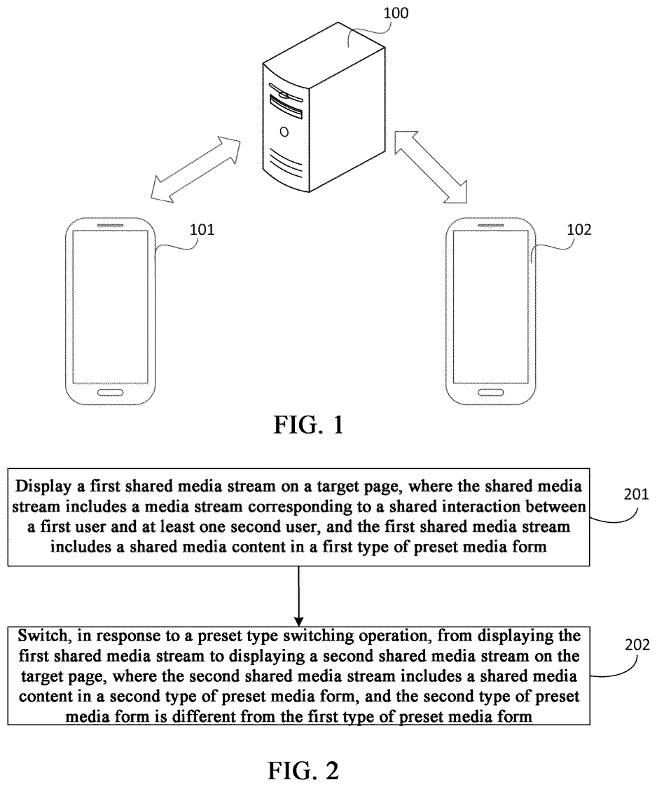

FIG. 1 is a scenario architecture diagram of an applicable application scenario for a media content display method according to an embodiment of the present disclosure. Referring to FIG. 1, the application scenario may include a server 100, a first electronic device 101, and a second electronic device 102. There may be more electronic devices, and the number of the electronic devices is not limited. FIG. 1 is only for illustrative purposes. The plurality of electronic devices may establish communication connections with the server to achieve information interaction. The electronic device may be a mobile device such as a mobile phone, a smartwatch, a tablet, and a personal digital assistant; or the electronic device may be a desk computer or other devices. Users using the electronic devices may conduct real-time calls, content sharing, message interactions, etc., through preset applications installed on the electronic devices. The content sharing may include media stream sharing (hereinafter referred to as a shared interaction). The server may provide support for the preset applications. Exemplarily, when the plurality of users engage in the shared interaction, each user may control a current shared video stream, such as switching to a previous video or a next video. In this embodiment of the present disclosure, the type of the preset applications is not limited, which may be, for example, a video application, a live streaming application, or a news application, and or may also be other types of applications.

FIG. 2 is a schematic flowchart of a media content display method according to an embodiment of the present disclosure. This embodiment of the present disclosure is applicable to a case of displaying a shared media content. The method may be performed by a media content display apparatus. The apparatus may be implemented in the form of software and/or hardware, such as an electronic device. As shown in FIG. 2, the method includes:

Step 201: Display a first shared media stream on a target page, where the shared media stream includes a media stream corresponding to a shared interaction between a first user and at least one second user, and the first shared media stream includes a shared media content in a first type of preset media form.

In this embodiment of the present disclosure, the first user is a user currently using a preset application, also known as a local user. It may be understood that an account currently logged in to the preset application is the account of the first user. The target page may be a page in the preset application that has the capability to display shared media streams, and the type of the target page is not limited.

In this embodiment of the present disclosure, two or more users may be supported in real-time media stream sharing. The second user may be a user who participates in the current media stream sharing with the first user, also known as a peer user. There may be one or more second users, and the number of the second users is not limited. The shared media stream includes the media stream corresponding to the shared interaction between the first user and the at least one second user. That is, each user participating in the shared interaction can view the shared media stream through his/her own electronic device. There are no limitations on the source of the shared media stream.

In this embodiment of the present disclosure, preset media forms may be classified based on formats of media data, and may include media forms such as audio, images, and videos. A first preset media form may be any one of the above media forms. The shared media content may refer to a media content in the shared media stream, which corresponds to the media form, such as an audio content, an image content, and a video content. Different media forms of shared media contents may be displayed in different ways. For example, the display of an audio-form shared media content may include playing a shared audio content and may also include displaying associated information of the shared audio content, and the associated information may include, for example, a song title, an artist, an album title, or lyrics. For another example, the display of a video-form shared media content may include playing audio in a shared video content and displaying video images in the shared video content.

In this embodiment of the present disclosure, the preset media forms may also be classified based on sources of the shared media content, which may include, for example, a source of work recommendation streams, a source of video live streams, and a source of favorite work libraries.

The preset media forms may also be classified based on formats of media data and sources of shared media contents. For example, different sources of shared media contents with the same format may correspond to different preset media forms, and different formats of shared media contents with the same source may also correspond to different preset media forms.

The first shared media stream including a shared media content in the first type of preset media form, may be that all or part of the shared media content included in the first shared media stream are in the first type of preset media form.

The proportion of the shared media content in the first type of preset media form in the first shared media stream is greater than or equal to a first preset proportion value. The first preset proportion value may be set according to actual situations and may be greater than 50%. For example, the first preset proportion value may be 100% or 95%, etc. Assuming that the preset media form with the highest proportion of the corresponding shared media content in the shared media stream is considered as a core media form in the shared media stream, and therefore the first type of preset media form may be considered as the core media form in the first shared media stream.

A proportion of the shared media content in the first type of preset media form in the first shared media stream is greater than a proportion of the shared media content in a second type of preset media form in the first shared media stream.

Exemplarily, for a shared media stream, a preset application may pull one or more shared media contents belonging to the shared media stream from a corresponding server side at a preset frequency. The shared media contents pulled within a preset number of pulls may be regarded as a content set to determine the proportions of shared media contents in different preset media forms within the content set. For example, for the first shared media stream, if 5 shared media contents are pulled each time and the preset number of pulls is 4, there are 20 shared media contents within the content set, and if the first preset proportion value is 95%, there are 19 shared media contents in the first type of preset media form. For another example, within the content set, if there are 18 shared media contents in the first type of preset media form and 2 shared media contents in the second type of preset media form, or if there are 20 shared media contents in the first type of preset media form and 0 shared media content in the second type of preset media form, a proportion of the shared media contents in the first type of preset media form in the first shared media stream is greater than a proportion of the shared media contents in the second type of preset media form in the first shared media stream.

Step 202: Switch, in response to a preset type switching operation, from displaying the first shared media stream to displaying a second shared media stream on the target page, where the second shared media stream includes the shared media content in the second type of preset media form, and the second type of preset media form is different from the first type of preset media form.

Exemplarily, the second type of preset media form may be any media form that is different from the first type of preset media form. For example, if the first type of preset media form is an audio form, the second type of preset media form may be an image form or a video form. For another example, if the first type of preset media form is a video form, the second type of preset media form can be an audio form or an image form. The second shared media stream including a shared media content in the second type of preset media form, may be that all or part of the shared media content in the second shared media stream are in the second type of preset media form.

The proportion of the shared media content in the second type of preset media form in the second shared media stream is greater than or equal to a second preset proportion value. The second preset proportion value may be set according to actual situations and may be greater than 50%. For example, the second preset proportion value may be 100% or 95%, such that the second type of preset media form becomes a core media form in the second shared media stream. The first preset proportion value and the second preset proportion value may be equal or unequal.

A proportion of the shared media content in the second type of preset media form in the second shared media stream is greater than a proportion of the shared media content in the first type of preset media form in the second shared media stream.

In this embodiment of the present disclosure, switching between the shared media streams including the shared media contents in the different media forms may be supported, and the user may perform the switching by inputting the preset type switching operation. The form of the preset type switching operation is not limited. For example, the preset type switching operation may be a trigger operation based on a preset switching control, or may be a preset gesture operation such as a double-tap operation, a single-finger swipe operation, or a multi-finger swipe operation, or may also be a voice command. After receiving the preset type switching operation, the shared media content in the first shared media stream that is currently displayed on the target page may be switched to the shared media content in the second shared media stream for display, and may be switched to the shared media content in the second type of preset media form in the second shared media stream for display.

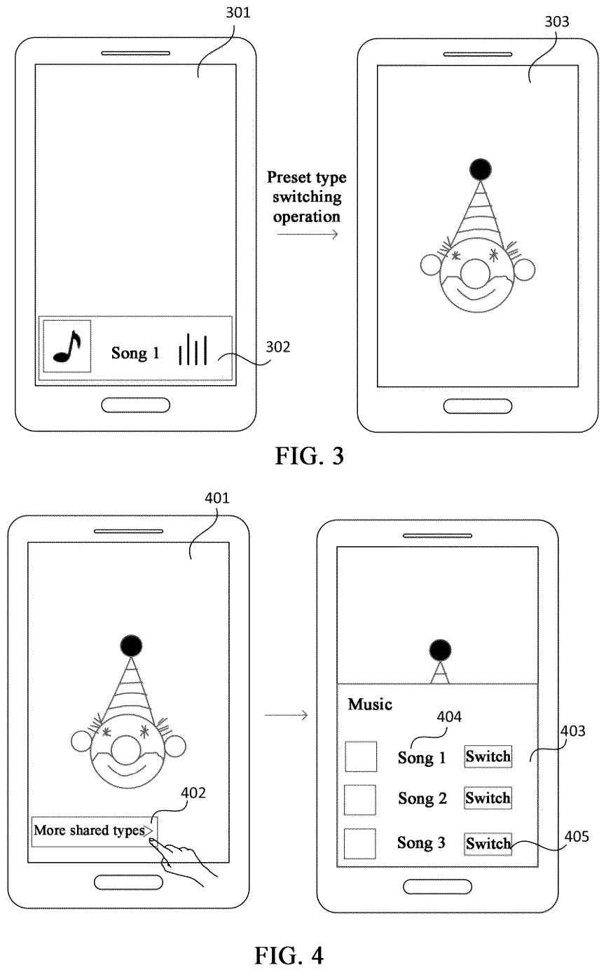

FIG. 3 is a schematic diagram of an interface interaction according to an embodiment of the present disclosure. For example, if the first type of preset media form is an audio form, the second type of preset media form may be a video form. On a target page 301, a first shared media stream is displayed. Assuming that a song 1 in the first shared media stream is currently displayed, associated information 302 of the song 1, such as a song icon, a song title, and a dynamic audio waveform, may be displayed in a preset area on the target page 301, and meanwhile the sound of the song 1 is played through a sound playback device such as a speaker or an earpiece. After receiving a preset type switching operation, the display on the target page 301 is switched to a second shared media stream, such as switching from displaying the song 1 to displaying a clown video 303 in the second shared media stream.

According to the media content display method provided by this embodiment of the present disclosure, the first shared media stream is displayed on the target page, where the shared media stream includes the media stream corresponding to the shared interaction between the first user and the at least one second user, and the first shared media stream includes the shared media content in the first type of preset media form; and in response to the preset type switching operation, the display of the first shared media stream is switched to the display of the second shared media stream on the target page, where the second shared media stream includes the shared media content in the second type of preset media form, and the second type of preset media form is different from the first type of preset media form. By adopting the above technical solution, the user may be provided with a display function of the shared media streams in different media forms, and the display between the shared media streams in different media forms may be flexibly switched.

In some embodiments, the step of switching, in response to a preset type switching operation, from displaying the first shared media stream to displaying a second shared media stream on the target page includes: displaying a preset switching control corresponding to the second shared media stream on the target page; and switching, in response to a trigger operation on the preset switching control corresponding to the second shared media stream, from displaying the first shared media stream to displaying the second shared media stream on the target page. The settings have the advantages that by triggering the preset switching control displayed on the target page, the display of the shared media streams in different media forms may be conveniently achieved.

Exemplarily, the preset switching control may be a resident control on the target page, or may be displayed when preset display conditions are met. The preset display conditions may be automatically triggered by the preset application or triggered by user operation.

In some embodiments, the displaying a preset switching control corresponding to the second shared media stream on the target page includes: displaying a media type switching area on the target page in response to a media type switching operation, and displaying, in the media type switching area, the preset switching control associated with a content identifier of the shared media content in the second type of preset media form in the second shared media stream. The settings have the advantages that by associating the preset switching control with the content identifier of the shared media content in the second type of preset media form in the second shared media stream, the user can more visually view which shared media contents can be displayed if switched to the second shared media stream, making it convenient for the user to decide whether to switch the shared media streams based on own preferences.

Exemplarily, the form of the media type switching operation is not limited. For example, the media type switching operation may be a trigger operation based on a preset media switching control, or may be a preset gesture operation such as a double-tap operation, a single-finger swipe operation, or a multi-finger swipe operation, or may also be a voice command. After receiving the media type switching operation, the media type switching area is displayed. In the area, the content identifier of the shared media content in the second type of preset media form may be displayed. The content identifier may be reused as an associated preset switching control, and the associated preset switching control may also be displayed in an associated area of the content identifier.

FIG. 4 is a schematic diagram of another interface interaction according to an embodiment of the present disclosure. For example, the first type of preset media form is a video form, and the second type of preset media form may be an audio form. As shown in FIG. 4, during the playback of a clown video on a target page 401, a preset media switching control 402 is displayed. After the user taps on the preset media switching control 402, a media type switching area 403 is displayed, and a content identifier 404 of a shared media content (a song) in an audio form is displayed in the media type switching area 403. The content identifier may be, for example, a song title, and an associated preset switching control 405 is displayed in an associated area (e.g., a right side in the figure) of the content identifier 404. The content identifier 404 may also be reused as a preset switching control to improve the utilization rate of page display space.

In some embodiments, the displaying, in the media type switching area, the preset switching control associated with a content identifier of the shared media content in the second type of preset media form in the second shared media stream includes: displaying a media type option corresponding to a plurality of shared media streams in the media type switching area, where the media type option corresponding to the plurality of shared media streams includes a media type option corresponding to the second shared media stream; and displaying, in response to a trigger operation on the media type option corresponding to the second shared media stream, an associated area of the media type option corresponding to the second shared media stream. The settings have the advantages that more shared media streams may be provided to the user to be selected, and shared media stream switching flexibility is improved.

In some embodiments, the method further includes: displaying, in the associated area, a preset switching control associated with the content identifier of the shared media content in the second type of preset media form in the second shared media stream. The settings have the advantages that the preset switching control associated with the content identifier corresponding to the same media type option is centrally displayed in the associated area, making it convenient for the user to quickly find the shared media content to be switched and then trigger switching.

Exemplarily, core media forms corresponding to the plurality of shared media streams may be different, and texts of the media type option may be set according to the corresponding core media forms to facilitate quick distinction by the user. The associated areas of different media type options may be the same or different. If the associated areas of the different media type options are the same, the content identifier displayed in the associated area may be updated when the selected media type option changes. For the different media type options, a display mode of the content identifiers in the associated areas may vary and may be set according to the corresponding preset media forms.

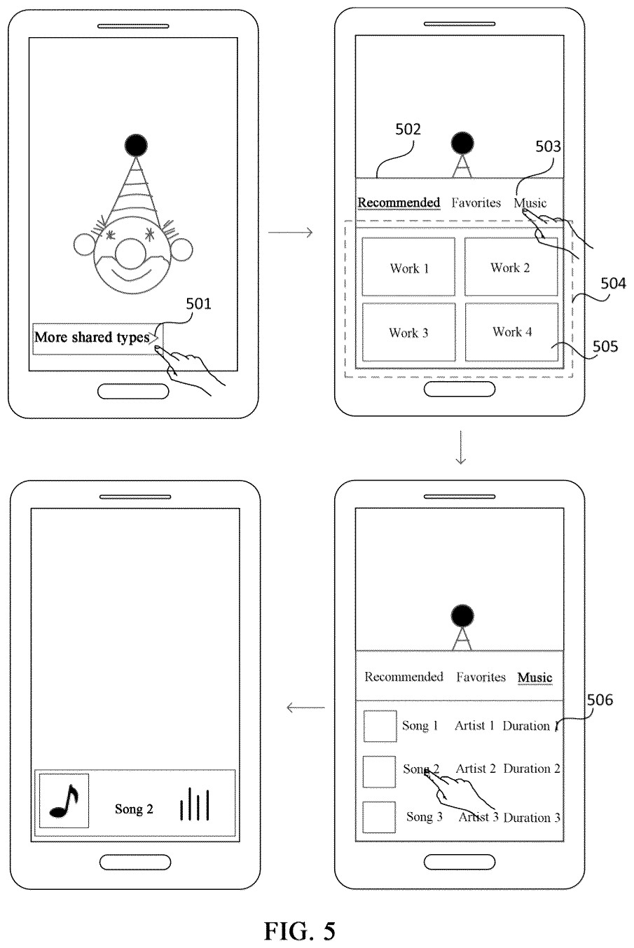

FIG. 5 is a schematic diagram of another interface interaction according to an embodiment of the present disclosure. As shown in FIG. 5, after the user taps on a preset media switching control 501, a media type switching area 502 is displayed, and may include two sub-areas. One sub-area is used to display media type options 503, such as “Recommended”, “Favorites”, and “Music” in the figure. The other sub-area is an associated area 504 of the media type options, which may be shared by the different media type options. When the media type switching area 502 is initially displayed, a first media type option may be set as a selected state by default, such as “Recommended” in the figure. In the associated area 504, content identifiers 505 of recommended works in a recommended work stream may be displayed, which may be cover images or video screenshots of the recommended works. When the user wants to select a shared media stream with music as a core media form, the user may tap on “Music” to change the display in the associated area 504 to show a content identifier 506 of the music in the shared media stream. As shown in FIG. 5, the content identifier 506 of the music may be different from a content identifier 505 of the recommended works. The content identifier 506 of the music may include a song icon, a song title, an artist name, a song duration, etc.

In some embodiments, the switching, in response to a trigger operation on the preset switching control corresponding to the second shared media stream, from displaying the first shared media stream to displaying the second shared media stream on the target page includes: switching, in response to a trigger operation on a preset switching control associated with a target content identifier, from displaying the first shared media stream on the target page to displaying a shared media content in the second shared media stream corresponding to the target content identifier. The settings have the advantages that the user can conveniently select, by triggering the preset switching control associated with the target content identifier, the first shared media content to be displayed after switching to the second shared media stream, thereby improving the shared media stream switching flexibility

As shown in FIG. 5, assuming that the content identifier 506 of the music is reused as an associated preset switching control, if the user wants to switch to a song 2, the user may tap on a content identifier of the song 2 to switch to a shared media stream with audio as a core media form, and the song 2 is directly displayed.

In some embodiments, the first shared media stream includes at least two media content groups in the first type of preset media form. A single media content group includes at least two consecutive shared media contents in the first type of preset media form. At least one shared media content in the second type of preset media form exists between every two adjacent media content groups. The step of switching, in response to a preset type switching operation, from displaying the first shared media stream to displaying a second shared media stream on the target page includes: in a case where the shared media content in the second type of preset media form in the first shared media stream is currently displayed on the target page, switching, in response to the preset type switching operation, from displaying the first shared media stream to displaying the second shared media stream on the target page. The settings have the advantages that shared media contents of other preset media forms may be inserted between consecutive shared media contents of the same preset media form, which may serve as a reminder to the user, indicating that the user may share contents of more media forms by switching the shared media streams. Moreover, the shared media content currently viewed by the user corresponds to the core media form of the second shared media stream that is about to be switched, thereby reducing the shared media stream selecting operation of the user.

Exemplarily, the number of at least two consecutive shared media contents in the first type of preset media form included in the single media content group may be preset, such as 10. For example, in 21 shared media contents, the shared media contents from 1 to 10, as well as the shared media contents from 12 to 21 are shared video contents, and the eleventh shared media content is a shared audio content.

In the case of currently displaying the media content in the first type of preset media form in the first shared media stream on the target page, switching to the second shared media stream may also be allowed. Different shared media stream switching methods may be set based on the different preset media forms of the currently displayed media contents in the first shared media stream. For example, in a case where the shared media content in the second type of preset media form in the first shared media stream is currently displayed on the target page, in response to a first preset type switching operation, displaying the first shared media stream is switched to displaying the second shared media stream on the target page; and in the case of currently displaying the shared media content in the first type of preset media form in the first shared media stream on the target page, in response to a second preset type switching operation, displaying the first shared media stream is switched to displaying the second shared media stream on the target page. The first preset type switching operation and the second preset type switching operation are different. For example, the first preset type switching operation may be a gesture operation such as long press or double tap, and the second preset type switching operation may be a trigger operation on the preset switching control corresponding to the second shared media stream.

In some embodiments, the second shared media stream may also include media content groups. The media content group in the first shared media stream is denoted as a first media content group. The second shared media stream includes at least two second media content groups in the second type of preset media form, and each second media content group includes at least two consecutive shared media contents in the second type of preset media form. At least one shared media content in the first type of preset media form exists between every two adjacent second media content groups.

In some embodiments, the preset application has a work publishing function, and the user may publish a created work through the work publishing work, such as a video work. The preset media form includes an audio form. The shared media content includes a shared audio content. The shared audio content includes original sound audio from the user-published video work. The settings have the advantages that sources of the shared audio content may be enriched, and display forms of video works may also be enriched. When the user publishing the video work creates the video work, the user may edit or mix an audio material with full authorization from an audio material owner, and use the processed audio as background music in the video work, also known as the original sound audio. Using the original sound audio in the video work as the shared audio content for display is an independent choice of the publisher of the video work.

In some embodiments, the preset media form includes an audio form, and the shared media content includes a shared audio content. The method further includes: updating a background of the target page based on a preset associated image of the currently displayed shared audio content on the target page. The settings have the advantages that for the shared audio content, the background of the target page can be dynamically updated in a targeted manner according to the associated image of the currently playing audio, making the background viewed by the user more matching with the audio.

The preset associated image may include, for example, an album cover of a shared audio content, a photo of an artist, and a cover image or a video screenshot of the associated video work. The background of the target page may be directly replaced with the preset associated image; or, at least one image processing operation of cropping, size ratio adjustment, color adjustment, and transparency adjustment may be performed based on the preset associated image to replace the background of the target page with an image obtained after the above image processing.

In some embodiments, the shared audio content includes original sound audio in a user-published video work and/or library music from a preset music library. The updating a background of the target page based on a preset associated image of the currently displayed shared audio content on the target page includes: displaying a first background of the target page using a first preset display mode in a case where the currently displayed shared audio content on the target page includes the original sound audio, where the first background includes a first preset associated image of the original sound audio; and displaying a second background of the target page using a second preset display mode in a case where the currently displayed shared audio content on the target page does not include user original sound audio but only includes the library music, where the second background includes a second preset associated image of the library music. The settings have the advantages that for different sources of shared audio contents, the background of the target page is updated using different display modes, thereby enriching the background display modes, and facilitating the user to conveniently distinguish the source of the current shared audio content.

Exemplarily, the preset music library may include music published by professionals (e.g., artists, musicians, or record companies) for which the preset application has obtained copyrights. The type of music is referred to as the library music in the embodiments of the present disclosure, and the library music may be used as the audio material mentioned above.

Exemplarily, the difference between the first preset display mode and the second preset display mode may be reflected in a background size, background transparency, background brightness, etc. For example, for the original sound audio, the first preset associated image may be a video frame from the associated video work. The video frame may be dynamically displayed, such as playing the video work to which the original sound audio belongs in the first background, and a size of the first background is smaller than a screen size; and for the library music, the second preset associated image may be an album cover, and a size of the second background may be equal to the screen size.

In some embodiments, the target page includes a message interaction page. The updating a background of the target page based on a preset associated image of the currently displayed shared audio content on the target page includes: determining a target background image based on the preset associated image of the currently displayed shared audio content on the target page; and replacing the current background of the target page with the target background image, such that a page content of the message interaction page is displayed on an upper layer of the target background image, where the page content includes a message content and/or an associated content of the message content. The settings have the advantages that the user may obtain a more immersive audio sharing interaction effect on the message interaction page.

Exemplarily, the page content on the message interaction page may include a message content and an associated content of the message content. The associated content may be an object identifier of a message interaction object (e.g., a user name or a user avatar). In this way, the user may view the preset associated image of the shared audio content in full screen (the target page is in a full-screen display state) while receiving and sending messages, thereby balancing functions of message interaction and audio sharing.

In some embodiments, the preset media form includes an audio form, and the shared media content includes a shared audio content. Displaying a shared audio content on the target page includes: displaying associated information of the shared audio content in a preset control of the target page, and playing the shared audio content on the target page. The settings have the advantages that the associated information of the shared audio content is displayed in the preset control, thereby reducing the occupation of a display space on the target page by the associated information, and allowing the user to obtain a more immersive audio sharing interaction effect.

Exemplarily, the preset control may be a preset floating control, which may be a control in the form of a floating window. The attributes of the preset floating control, such as a shape, a size, a color, transparency, and a display position, may be set according to actual needs. The preset control may also be a preset strip control. For example, at least one boundary of the preset strip control coincides with a boundary of the target page to reduce interference with other contents on the target page.

The preset control may also display a shared interaction message. The shared interaction message may include a text message, and may also include an image message, such as an expression image. Therefore, when browsing the target page, the first user may also view an interaction message sent by the second user in time. In this case, the target page may be a preset page. The preset page may include a page other than the message interaction page, such as a news page, a product detail page, or a personal homepage.

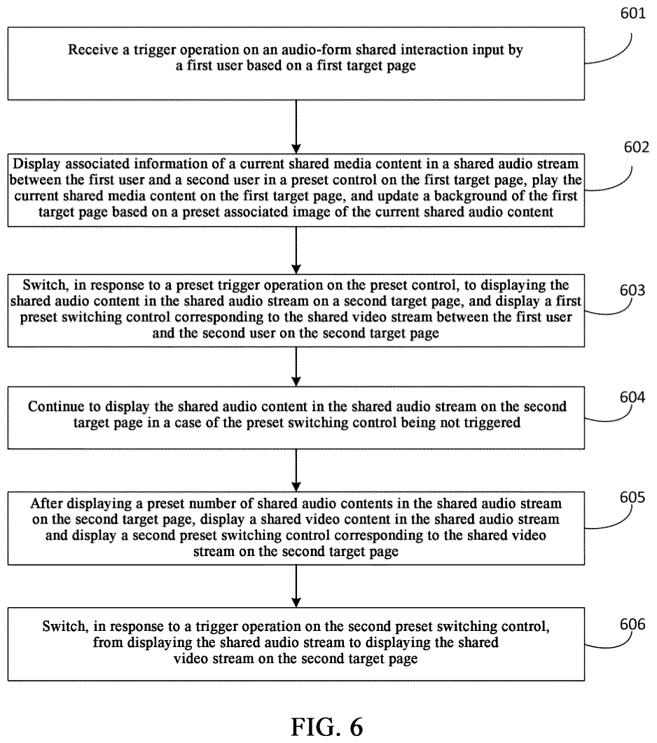

FIG. 6 is a schematic flowchart of another media content display method according to an embodiment of the present disclosure. This embodiment of the present disclosure is described based on the solutions in the above embodiments. Using an example that a first type of preset media form is an audio form and a second type of preset media form is a video form, a proportion of a shared audio content in a first shared media stream (denoted as a shared audio stream) is greater than a proportion of a shared video content, and a proportion of a shared video content in a second shared media stream (denoted as a shared video stream) is greater than the proportion of the shared audio content.

The method includes the following steps:

Step 601: Receive a trigger operation on an audio-form shared interaction input by a first user based on a first target page.

Exemplarily, the first target page is a message interaction page. The trigger operation on the shared interaction may be sending an invitation for an audio shared interaction to a second user, or accepting an invitation for the audio shared interaction sent by the second user.

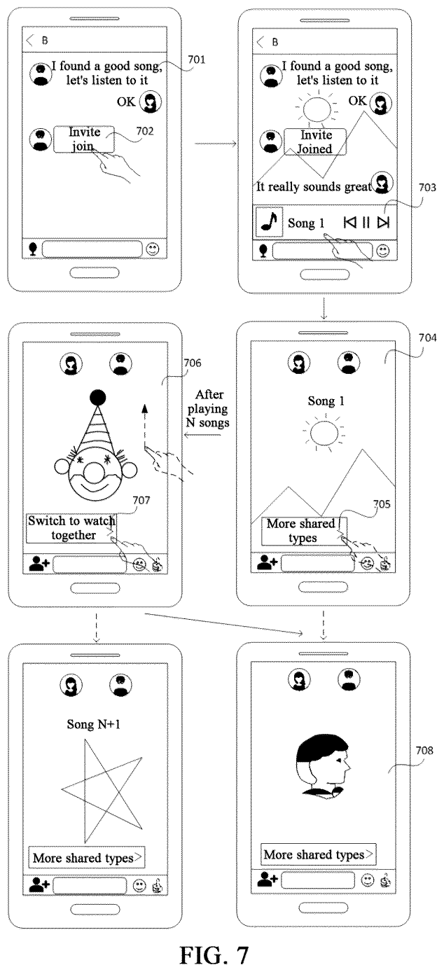

FIG. 7 is a schematic diagram of another interface interaction according to an embodiment of the present disclosure. As shown in FIG. 7, assuming that the first user is a user A and the second user is a user B, the user B sends an invitation for an audio shared interaction to the user A. On a message interaction page 701 on the side of the user A, an invitation control 702 is displayed. After the user A taps on the invitation control 702, the audio shared interaction may be conducted (also known as “Listen Together”).

Step 602: Display associated information of a current shared media content in a shared audio stream between the first user and the second user in a preset control on the first target page, play the current shared media content on the first target page, and update a background of the first target page based on a preset associated image of the current shared audio content.

As shown in FIG. 7, after the audio shared interaction is conducted, associated information of a currently displayed song 1 (the shared audio content) may be displayed in a playback bar control 703 (a preset control) on the first target page. The associated information includes, for example, a song icon, a song title, and playback control buttons (e.g., previous track, pause, and next track) shown in the figure, and the sound of the song 1 is played on the first target page. Assuming that the song 1 is background music in a video work published by a user, a video cover or a video screenshot of the video work (e.g., a scenic image in FIG. 7) may be used as a preset associated image of the song 1, and the scenic image is used to replace an original background of the first target page, that is, the scenic image becomes a new current background of the first target page. Message contents, avatars, and other associated contents between the user A and the user B are displayed on an upper layer of the scenic image to ensure a normal message interaction between the user A and the user B, and the effects of message interaction and audio sharing are balanced.

The user B may input a preset type switching operation by triggering the preset control in a first preset triggering manner (e.g., the preset control may be reused as a preset switching control), thereby switching from displaying the shared audio stream to displaying the shared video stream on the first target page.

The user B may input a media type switching operation by triggering the preset control in a second preset triggering manner, display a media type switching area on the first target page, and display a preset switching control associated with a content identifier of a shared video content in the shared video stream in the media type switching area. For details, reference may be made to related descriptions of FIG. 4 and FIG. 5, which will not be repeated herein.

Step 603: Switch, in response to a preset trigger operation on the preset control, to displaying the shared audio content in the shared audio stream on a second target page, and display a first preset switching control corresponding to the shared video stream between the first user and the second user on the second target page.

Exemplarily, as shown in FIG. 7, after the user A inputs the preset trigger operation such as long press or tap on the playback bar control 703, the song 1 is continuously displayed by switching to a second target page 704. The second target page may be another shared page for the shared interaction. On the second target page, user identifiers of users participating in the shared interaction may be displayed, such as the avatars of the user A and the user B, and the associated information of the shared audio content may be displayed, such as the song tile. The preset associated image of the current shared audio content may also be used as a background of the second target page.

On the second target page, the shared media content may be switched by inputting a specified gesture operation. For example, an upward swipe operation corresponds to switching to a next shared media content, and a downward swipe operation corresponds to switching to a previous shared media content.

Exemplarily, as shown in FIG. 7, on the second target page, a first preset switching control 705 corresponding to the shared video stream may also be displayed. The user A may switch, by triggering the first preset switching control 705, from displaying the song 1 to displaying the shared video content in the shared video stream on the second target page, such as a character video 708 in FIG. 7.

The first preset switching control 705 may be replaced with a preset media switching control. The user A may input a media type switching operation by triggering the preset media switching control, thereby selecting and switching shared media streams corresponding to more media forms. For details, reference may be made to the above related descriptions of FIG. 4 and FIG. 5, which will not be repeated herein.

Step 604: Continue to display the shared audio content in the shared audio stream on the second target page if the preset switching control is not triggered.

Exemplarily, the shared audio stream includes a plurality of audio content groups. A single audio content group includes a preset number (denoted as N) of consecutive shared audio contents, and one shared video content exists between every two adjacent audio content groups.

Step 605: After displaying a preset number of shared audio contents in the shared audio stream on the second target page, display a shared video content in the shared audio stream and display a second preset switching control corresponding to the shared video stream on the second target page.

As shown in FIG. 7, after consecutively playing the N shared audio contents, the current audio content group is completely played and is automatically switched to the shared video content in the shared audio stream to be played on the second target page, such as a clown video 706 in FIG. 7. In addition, a second preset switching control 707 corresponding to the shared video stream is displayed on the second target page. Texts corresponding to the first preset switching control 705 and the second preset switching control 707 may be the same or different. As shown in FIG. 7, the texts corresponding to the first preset switching control 705 and the second preset switching control 707 may be different, which are respectively “More Shared Types” and “Switch to Watch Together”.

Step 606: Switch, in response to a trigger operation on the second preset switching control, from displaying the shared audio stream to displaying the shared video stream on the second target page.

Exemplarily, as shown in FIG. 7, after the user A triggers the second preset switching control 707, the display of the clown video 706 in the shared audio stream may be switched to the character video 708 in the shared video stream, thereby switching from the shared audio stream to the shared video stream.

After switching to the shared video stream on the second target page, the first preset switching control may also be continuously displayed on the second target page, thereby allowing the user A to switch back to the shared audio stream.

Exemplarily, as shown in FIG. 7, if the user A still wants to continue sharing the audio during playing the clown video 706, the user A may switch to displaying a next audio content group by inputting the upward swipe operation, such as a song N+1. The background of the second target page may be switched to a preset associated image of the song N+1, such as a star image in the figure.

According to the media content display method provided by this embodiment of the present disclosure, two different target pages for displaying the shared media content may be provided for the shared media stream. The different target pages may correspond to different display modes. On the target page, the user may be allowed to flexibly switch from displaying shared media contents in different preset media forms in a shared media stream primarily in one media form to displaying a shared media stream primarily in another media form, and diverse switching methods are provided. In addition, when the shared audio content is displayed, the page background may be adaptively adjusted on the target page based on the associated image of the currently displayed shared audio content.

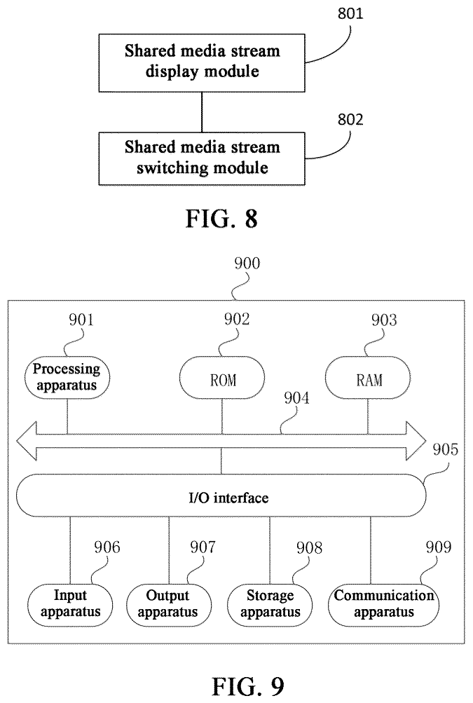

FIG. 8 is a schematic diagram of a structure of a media content display apparatus according to an embodiment of the present disclosure. As shown in FIG. 8, the apparatus includes: a shared media stream display module 801 and a shared media stream switching module 802.

The shared media stream display module 801 is configured to display a first shared media stream on a target page, where the shared media stream includes a media stream corresponding to a shared interaction between a first user and at least one second user, and the first shared media stream includes a shared media content in a first type of preset media form; and the shared media stream switching module 802 is configured to switch, in response to a preset type switching operation, from displaying the first shared media stream to displaying a second shared media stream on the target page, where the second shared media stream includes a shared media content in a second type of preset media form, and the second type of preset media form is different from the first type of preset media form.

According to the media content display apparatus provided by this embodiment of the present disclosure, the first shared media stream is displayed on the target page, where the shared media stream includes the media stream corresponding to the shared interaction between the first user and the at least one second user, and the first shared media stream includes the shared media content in the first type of preset media form; and in response to the preset type switching operation, the display of the first shared media stream is switched to the display of the second shared media stream on the target page, where the second shared media stream includes the shared media content in the second type of preset media form, and the second type of preset media form is different from the first type of preset media form. By adopting the above technical solution, the user may be provided with a display function of the shared media streams in different media forms, and the display between the shared media streams in different media forms may be flexibly switched.

A proportion of the shared media content in the first type of preset media form in the first shared media stream is greater than a proportion of the shared media content in the second type of preset media form in the first shared media stream; and the proportion of the shared media content in the second type of preset media form in the second shared media stream is greater than a proportion of the shared media content in the first type of preset media form in the second shared media stream.

The shared media stream switching module 802 includes:
a switching control display unit, configured to display a preset switching control corresponding to the second shared media stream on the target page; and a switching unit, configured to switch, in response to a trigger operation on the preset switching control corresponding to the second shared media stream, from displaying the first shared media stream to displaying the second shared media stream on the target page.

The switching control display unit includes:
an area display subunit, configured to display a media type switching area on the target page in response to a media type switching operation; and a switching control display subunit, configured to display, in the media type switching area, a preset switching control associated with a content identifier of the shared media content in the second type of preset media form in the second shared media stream.

The switching control display subunit is configured to:
display a media type option corresponding to a plurality of shared media streams in the media type switching area, where the media type option corresponding to the plurality of shared media streams includes a media type option corresponding to the second shared media stream; and display, in response to a trigger operation on the media type option corresponding to the second shared media stream, an associated area of the media type option corresponding to the second shared media stream.

The switching control display subunit is further configured to: display, in the associated area, a preset switching control associated with the content identifier of the shared media content in the second type of preset media form in the second shared media stream.

The switching unit is configured to:
switch, in response to a trigger operation on a preset switching control associated with a target content identifier, from displaying the first shared media stream on the target page to displaying a shared media content in the second shared media stream corresponding to the target content identifier.

The first shared media stream includes at least two media content groups in the first type of preset media form. A single media content group includes at least two consecutive shared media contents in the first type of preset media form. At least one shared media content in the second type of preset media form exists between every two adjacent media content groups.

The shared media stream switching module 802 is configured to:
switch, in response to the preset type switching operation, from displaying the first shared media stream to displaying the second shared media stream on the target page in a case where the shared media content in the second type of preset media form in the first shared media stream is currently displayed on the target page.

The preset media form includes an audio form. The shared media content includes a shared audio content. The apparatus further includes:
a background update module, configured to update a background of the target page based on a preset associated image of the currently displayed shared audio content on the target page.

The target page includes a message interaction page. The background update module includes:
a background determination unit, configured to determine a target background image based on the preset associated image of the currently displayed shared audio content on the target page; and a background replacement unit, configured to replace the current background of the target page with the target background image, such that a page content of the message interaction page is displayed on an upper layer of the target background image, where the page content includes a message content and/or an associated content of the message content.

The preset media form includes an audio form, and the shared media content includes a shared audio content. When performing an operation of displaying the shared audio content on the target page, the shared media stream display module is configured to: display associated information of the shared audio content in a preset control of the target page, and play the shared audio content on the target page.

The preset media form includes an audio form. The shared media content includes a shared audio content. The shared audio content includes original sound audio from a user-published video work

The shared audio content includes original sound audio in a user-published video work and/or library music from a preset music library. The background update module includes:
a first background update unit, configured to display a first background of the target page using a first preset display mode in a case where the currently displayed shared audio content on the target page includes the original sound audio, where the first background includes a first preset associated image of the original sound audio; and a second background update unit, configured to display a second background of the target page using a second preset display mode in a case where the currently displayed shared audio content on the target page is the library music, where the second background includes a second preset associated image of the library music.

The media content display apparatus provided by this embodiment of the present disclosure may perform the media content display method provided by any embodiment of the present disclosure and has the corresponding functional modules and effects for performing the method.

The plurality of units and modules included in the above apparatus are only divided according to functional logics, but are not limited to the above division, as long as the corresponding functions can be achieved; and in addition, the names of the plurality of functional units are only for the convenience of distinguishing each other, and are not intended to limit the scope of protection of the embodiments of the present disclosure.

FIG. 9 is a schematic diagram of a structure of an electronic device according to an embodiment of the present disclosure. Reference is made to FIG. 9 below, which is a schematic diagram of a structure of an electronic device (e.g., a terminal device or a server in FIG. 9) 900 suitable for implementing an embodiment of the present disclosure. The terminal device in this embodiment of the present disclosure may include mobile terminals such as a mobile phone, a notebook computer, a digital radio receiver, a personal digital assistant (PDA), a portable Android device (PAD), a portable media player (PMP), and a vehicle-mounted terminal (e.g., a vehicle-mounted navigation terminal), and fixed terminals such as a digital television (TV) and a desk computer. The terminal device 900 shown in FIG. 9 is merely an example, which should not impose any limitations on functions and scope of use of this embodiment of the present disclosure.

As shown in FIG. 9, the electronic device 900 may include a processing apparatus (e.g., a central processing unit and a graphics processing unit) 901, which may perform various appropriate actions and processing according to a program stored on a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Typically, the following apparatuses may be connected to the I/O interface 905: an input apparatus 906, including, for example, a touchscreen, a touchpad, a keyboard, a mouse, a camera, a microphone, an accelerometer, and a gyroscope; an output apparatus 907, including, for example, a liquid crystal display (LCD), a speaker, and a vibrator; the storage apparatus 908, including, for example, a magnetic tape and a hard drive; and a communication apparatus 909. The communication apparatus 909 may allow the electronic device 900 to be in wireless or wired communication with other devices for data exchange. Although FIG. 9 illustrates the electronic device 900 with various apparatuses, it is not necessary to implement or have all the shown apparatuses. It may be an alternative to implement or have more or fewer apparatuses.

According to this embodiment of the present disclosure, the foregoing process described with reference to the flowchart may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network by the communication apparatus 909, or installed from the storage apparatus 908, or installed from the ROM 902. The computer program, when executed by the processing apparatus 901, performs the above functions limited in the method in this embodiment of the present disclosure.

The names of messages or information exchanged between a plurality of apparatuses in the implementations of the present disclosure are used for illustrative purposes only, and are not used to limit the scope of these messages or information.

The electronic device provided by this embodiment of the present disclosure and the media content display method provided by the above embodiment belong to the same concept, and for technical details not described in detail in this embodiment, reference may be made to the above embodiment. This embodiment and the above embodiment have the same effects.

An embodiment of the present disclosure provides a computer storage medium, storing a computer program. The program, when executed by a processor, implements the media content display method provided by the above embodiment.

The computer-readable medium in the present disclosure may be a computer-readable signal medium, or a computer-readable storage medium, or any combination of the above. For example, the computer-readable storage medium may include: electrical, magnetic, optical, electromagnetic, infrared, or semiconductor systems, apparatuses, or devices, or any combination of the above. Examples of the computer-readable storage medium may include: an electrical connection with one or more wires, a portable computer disk, a hard drive, a RAM, a ROM, an erasable programmable read-only memory (EPROM or a flash memory), an optical fiber, a portable compact disc read-only memory (CD-ROM), an optical storage device, a magnetic storage device, or any proper combination of the above. In the present disclosure, the computer-readable storage medium may be any tangible medium including or storing a program, and the program may be used by or in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium including: a wire, an optical cable, radio frequency (RF), etc., or any suitable combination of the above.

In some implementations, a client and a server may communicate using any currently known or future-developed network protocols such as a hypertext transfer protocol (HTTP), and may also be interconnected with digital data communication in any form or medium (e.g., a communication network). Examples of the communication network include a local area network (LAN), a wide area network (WAN), an internetwork (e.g., the Internet), a peer-to-peer network (e.g., an ad hoc peer-to-peer network), and any currently known or future-developed network.

The computer-readable medium may be included in the above electronic device; or may also separately exist without being assembled in the electronic device.

The above computer-readable medium carries one or more programs, and the one or more programs, when executed by the electronic device, cause the electronic device to: display a first shared media stream on a target page, where the shared media stream includes a media stream corresponding to a shared interaction between a first user and at least one second user, and the first shared media stream includes a shared media content in a first type of preset media form; and switch, in response to a preset type switching operation, from displaying the first shared media stream to displaying a second shared media stream on the target page, where the second shared media stream includes a shared media content in a second type of preset media form, and the second type of preset media form is different from the first type of preset media form.

Computer program code for performing the operations in the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a LAN or WAN, or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code includes one or more executable instructions for implementing specified logic functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. The name of the module does not limit the module itself in a certain case. For example, the shared media stream display module may also be described as “a module for displaying a first shared media stream on a target page, where the shared media stream includes a media stream corresponding to a shared interaction between a first user and at least one second user, and the first shared media stream includes a shared media content in a first type of preset media form”.

Herein, the functions described above may be at least partially executed by one or more hardware logic components. For example, exemplary hardware logic components that can be used include, but are not limited to: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or any suitable combination of the above content. Examples of the machine-readable storage medium may include: an electrical connection based on one or more wires, a portable computer disk, a hard drive, a RAM, a ROM, an EPROM or a flash, an optical fiber, a CD-ROM, an optical storage device, a magnetic storage device, or any suitable combination of the above content.

According to one or more embodiments of the present disclosure, a media content display method is provided, and includes:
displaying a first shared media stream on a target page, where the shared media stream includes a media stream corresponding to a shared interaction between a first user and at least one second user, and the first shared media stream includes a shared media content in a first type of preset media form; and
switching, in response to a preset type switching operation, from displaying the first shared media stream to displaying a second shared media stream on the target page, where the second shared media stream includes a shared media content in a second type of preset media form, and the second type of preset media form is different from the first type of preset media form.

According to one or more embodiments of the present disclosure, in the first shared media stream, a proportion of the shared media content in the first type of preset media form in the first shared media stream is greater than a proportion of the shared media content in the second type of preset media form in the first shared media stream; and a proportion of the shared media content in the second type of preset media form in the second shared media stream is greater than a proportion of the shared media content in the first type of preset media form in the second shared media stream.

According to one or more embodiments of the present disclosure, the switching, in response to a preset type switching operation, from displaying the first shared media stream to displaying a second shared media stream on the target page includes:
displaying a preset switching control corresponding to the second shared media stream on the target page; and
switching, in response to a trigger operation on the preset switching control corresponding to the second shared media stream, from displaying the first shared media stream to displaying the second shared media stream on the target page.

According to one or more embodiments of the present disclosure, the displaying a preset switching control corresponding to the second shared media stream on the target page includes:
displaying a media type switching area on the target page in response to a media type switching operation, and displaying, in the media type switching area, a preset switching control associated with a content identifier of the shared media content in the second type of preset media form in the second shared media stream.

According to one or more embodiments of the present disclosure, the displaying, in the media type switching area, a preset switching control associated with a content identifier of the shared media content in the second type of preset media form in the second shared media stream includes:
displaying a media type option corresponding to a plurality of shared media streams in the media type switching area, where the media type option corresponding to the plurality of shared media streams includes a media type option corresponding to the second shared media stream; and
displaying, in response to a trigger operation on the media type option corresponding to the second shared media stream, an associated area of the media type option corresponding to the second shared media stream.

According to one or more embodiments of the present disclosure, the method further includes:
displaying, in the associated area, a preset switching control associated with the content identifier of the shared media content in the second type of preset media form in the second shared media stream.

According to one or more embodiments of the present disclosure, the switching, in response to a trigger operation on the preset switching control corresponding to the second shared media stream, from displaying the first shared media stream to displaying the second shared media stream on the target page includes:
switching, in response to a trigger operation on a preset switching control associated with a target content identifier, from displaying the first shared media stream on the target page to displaying a shared media content in the second shared media stream corresponding to the target content identifier.

According to one or more embodiments of the present disclosure, the first shared media stream includes at least two media content groups in the first type of preset media form, a single media content group includes at least two consecutive shared media contents in the first type of preset media form, and at least one shared media content in the second type of preset media form exists between every two adjacent media content groups.

According to one or more embodiments of the present disclosure, the switching, in response to a preset type switching operation, from displaying the first shared media stream to displaying a second shared media stream on the target page includes:
switching, in response to the preset type switching operation, from displaying the first shared media stream to displaying the second shared media stream on the target page in a case where the shared media content in the second type of preset media form in the first shared media stream is currently displayed on the target page.

According to one or more embodiments of the present disclosure, the preset media form includes an audio form, the shared media content includes a shared audio content, and the method further includes:
updating a background of the target page based on a preset associated image of the currently displayed shared audio content on the target page.

According to one or more embodiments of the present disclosure, the target page includes a message interaction page; and the updating a background of the target page based on a preset associated image of the currently displayed shared audio content on the target page includes:
determining a target background image based on the preset associated image of the currently displayed shared audio content on the target page; and
replacing the current background of the target page with the target background image, such that a page content of the message interaction page is displayed on an upper layer of the target background image, where the page content includes a message content and/or an associated content of the message content.

According to one or more embodiments of the present disclosure, the preset media form includes an audio form, and the shared media content includes a shared audio content,
where displaying a shared audio content on the target page includes:
displaying associated information of the shared audio content in a preset control of the target page, and playing the shared audio content on the target page.

According to one or more embodiments of the present disclosure, the preset media form includes an audio form, the shared media content includes a shared audio content, and the shared audio content includes background music from a user-published video work.

According to one or more embodiments of the present disclosure, the shared audio content includes original sound audio in a user-published video work and library music from a preset music library,
where the updating a background of the target page based on a preset associated image of the currently displayed shared audio content on the target page includes:
displaying a first background of the target page using a first preset display mode in a case where the currently displayed shared audio content on the target page includes the original sound audio, where the first background includes a first preset associated image of the original sound audio; and
displaying a second background of the target page using a second preset display mode in a case where the currently displayed shared audio content on the target page is the library music, where the second background includes a second preset associated image of the library music.

According to one or more embodiments of the present disclosure, a media content display apparatus is provided, and includes:
a shared media stream display module, configured to display a first shared media stream on a target page, where the shared media stream includes a media stream corresponding to a shared interaction between a first user and at least one second user, and the first shared media stream includes a shared media content in a first type of preset media form; and
a shared media stream switching module, configured to switch, in response to a preset type switching operation, from displaying the first shared media stream to displaying a second shared media stream on the target page, where the second shared media stream includes a shared media content in a second type of preset media form, and the second type of preset media form is different from the first type of preset media form.

According to one or more embodiments of the present disclosure, an electronic device is provided. The electronic device includes:
one or more processors; and
a storage apparatus, configured to store one or more programs,
where the one or more programs, when executed by the one or more processors, cause the one or more processors to implement the media content display method according to this embodiment of the present disclosure.

According to one or more embodiments of the present disclosure, a storage medium including computer-executable instructions is provided. The computer-executable instructions, when executed by a computer processor, are used to perform the media content display method according to this embodiment of the present disclosure.

According to one or more embodiments of the present disclosure, a computer program product is provided, and includes a computer program carried on a non-transitory computer-readable medium. The computer program includes program code used to perform the media content display method according to this embodiment of the present disclosure.

Further, although the plurality of operations are described in a particular order, it should not be understood as requiring these operations to be performed in the shown particular order or in a sequential order. In certain environments, multitasking and parallel processing may be advantageous. Similarly, although several implementation details are included in the above discussion, these implementation details should not be interpreted as limitations on the scope of the present disclosure. Some features described in the context of separate embodiments may also be implemented in combination in a single embodiment. In contrast, various features described in the context of a single embodiment may also be implemented in a plurality of embodiments separately or in any suitable subcombination.

1. A media content display method, comprising:
displaying a first media stream on a presenting page, wherein the media stream comprises a media stream corresponding to a shared interaction between a first user and at least one second user, and the first media stream comprises a shared media content in a first type of preset media form; and
switching, in response to a preset type switching operation, from displaying the first media stream to displaying a second media stream on the presenting page, wherein the second media stream comprises a shared media content in a second type of preset media form, and the second type of preset media form is different from the first type of preset media form.

2. The method according to claim 1, wherein a proportion of the shared media content in the first type of preset media form in the first media stream is greater than a proportion of the shared media content in the second type of preset media form in the first media stream; and a proportion of the shared media content in the second type of preset media form in the second media stream is greater than a proportion of the shared media content in the first type of preset media form in the second media stream.

3. The method according to claim 1, wherein the switching, in response to a preset type switching operation, from displaying the first media stream to displaying a second shared media stream on the presenting page comprises:
displaying a preset switching control corresponding to the second media stream on the presenting page; and
switching, in response to a trigger operation on the preset switching control corresponding to the second media stream, from displaying the first media stream to displaying the second media stream on the presenting page.

4. The method according to claim 3, wherein the displaying a preset switching control corresponding to the second media stream on the presenting page comprises:
displaying a media type switching area on the presenting page in response to a media type switching operation, and displaying, in the media type switching area, a preset switching control associated with a content identifier of the shared media content in the second type of preset media form in the second media stream.

5. The method according to claim 4, wherein the displaying, in the media type switching area, a preset switching control associated with a content identifier of the shared media content in the second type of preset media form in the second media stream comprises:
displaying a media type option corresponding to a plurality of media streams in the media type switching area, wherein the media type option corresponding to the plurality of media streams comprises a media type option corresponding to the second media stream; and
displaying, in response to a trigger operation on the media type option corresponding to the second media stream, an associated area of the media type option corresponding to the second media stream.

6. The method according to claim 5, further comprising:
displaying, in the associated area, a preset switching control associated with the content identifier of the shared media content in the second type of preset media form in the second media stream.

7. The method according to claim 3, wherein the switching, in response to a trigger operation on the preset switching control corresponding to the second media stream, from displaying the first media stream to displaying the second media stream on the presenting page comprises:
switching, in response to a trigger operation on a preset switching control associated with a target content identifier, from displaying the first media stream to displaying a shared media content in the second media stream corresponding to the target content identifier on the presenting page.

8. The method according to claim 1, wherein the first media stream comprises at least two media content groups in the first type of preset media form, a single media content group comprises at least two consecutive shared media contents in the first type of preset media form, and at least one shared media content in the second type of preset media form exists between every two adjacent media content groups.

9. The method according to claim 8, wherein the switching, in response to a preset type switching operation, from displaying the first media stream to displaying a second media stream on the presenting page comprises:
switching, in response to the preset type switching operation, from displaying the first media stream to displaying the second media stream on the presenting page in a case where the shared media content in the second type of preset media form in the first media stream is currently displayed on the presenting page.

10. The method according to claim 1, wherein the preset media form comprises an audio form, the shared media content comprises a shared audio content, and the method further comprises:
updating a background of the presenting page based on a preset associated image of the currently displayed shared audio content on the presenting page.

11. The method according to claim 10, wherein the presenting page comprises a message interaction page; and the updating a background of the presenting page based on a preset associated image of the currently displayed shared audio content on the presenting page comprises:
determining a target background image based on the preset associated image of the currently displayed shared audio content on the presenting page; and
replacing the current background of the presenting page with the target background image, such that a page content of the message interaction page is displayed on an upper layer of the target background image, wherein the page content comprises at least one of a message content and an associated content of the message content.

12. The method according to claim 1, wherein the preset media form comprises an audio form, and the shared media content comprises a shared audio content; and
wherein displaying the shared audio content on the presenting page comprises:
displaying associated information of the shared audio content in a preset control of the presenting page, and playing the shared audio content on the presenting page.

13. The method according to claim 1, wherein the preset media form comprises an audio form, the shared media content comprises a shared audio content, and the shared audio content comprises original sound audio from a user-published video work.

14. The method according to claim 10, wherein the shared audio content comprises at least one of original sound audio in a user-published video work and library music from a preset music library; and
wherein the updating a background of the presenting page based on a preset associated image of the currently displayed shared audio content on the presenting page comprises:
displaying a first background of the presenting page using a first preset display mode in a case where the currently displayed shared audio content on the presenting page comprises the original sound audio, wherein the first background comprises a first preset associated image of the original sound audio; and
displaying a second background of the presenting page using a second preset display mode in a case where the currently displayed shared audio content on the presenting page is the library music, wherein the second background comprises a second preset associated image of the library music.

15-16. (canceled)

17. An electronic device, comprising:
at least one processor; and
a storage apparatus, configured to store at least one program,
wherein the at least one program, when executed by the at least one processor, causes the at least one processor to:
display a first media stream on a presenting page, wherein the media stream comprises a media stream corresponding to a shared interaction between a first user and at least one second user, and the first media stream comprises a shared media content in a first type of preset media form; and
switch, in response to a preset type switching operation, from displaying the first media stream to displaying a second media stream on the presenting page, wherein the second media stream comprises a shared media content in a second type of preset media form, and the second type of preset media form is different from the first type of preset media form.

18. A non-transitory computer-readable medium comprising computer-executable instructions, wherein the computer-executable instructions, when executed by a computer processor, are used to:
display a first media stream on a presenting page, wherein the media stream comprises a media stream corresponding to a shared interaction between a first user and at least one second user, and the first media stream comprises a shared media content in a first type of preset media form; and
switch, in response to a preset type switching operation, from displaying the first media stream to displaying a second media stream on the presenting page, wherein the second media stream comprises a shared media content in a second type of preset media form, and the second type of preset media form is different from the first type of preset media form.

19. (canceled)

20. The non-transitory computer-readable medium according to claim 18, wherein a proportion of the shared media content in the first type of preset media form in the first media stream is greater than a proportion of the shared media content in the second type of preset media form in the first media stream; and a proportion of the shared media content in the second type of preset media form in the second media stream is greater than a proportion of the shared media content in the first type of preset media form in the second media stream.

21. The non-transitory computer-readable medium according to claim 18, wherein the computer-executable instructions for switching, in response to a preset type switching operation, from displaying the first media stream to displaying a second media stream on the presenting page, are further used to:
display a preset switching control corresponding to the second media stream on the presenting page; and
switch, in response to a trigger operation on the preset switching control corresponding to the second media stream, from displaying the first media stream to displaying the second media stream on the presenting page.

22. The non-transitory computer-readable medium according to claim 21, wherein the computer-executable instructions for displaying a preset switching control corresponding to the second media stream on the presenting page, are further used to:
display a media type switching area on the presenting page in response to a media type switching operation, and display, in the media type switching area, a preset switching control associated with a content identifier of the shared media content in the second type of preset media form in the second media stream.

23. The non-transitory computer-readable medium according to claim 22, wherein the computer-executable instructions for displaying, in the media type switching area, a preset switching control associated with a content identifier of the shared media content in the second type of preset media form in the second media stream, are further used to:
display a media type option corresponding to a plurality of media streams in the media type switching area, wherein the media type option corresponding to the plurality of media streams comprises a media type option corresponding to the second media stream; and
display, in response to a trigger operation on the media type option corresponding to the second media stream, an associated area of the media type option corresponding to the second media stream.
